(19) United States
(12) Patent Application Publication
(10) Pub. No.: US 2026/0102827 A1
(43) Pub. Date: Apr. 16, 2026

(54) PLUNGE CUTTING APPARATUSES AND CUTTING INSERTS FOR SAME

(71) Applicant: Kennametal Inc., Latrobe, PA (US)

(72) Inventor: Jean Luc D. DUFOUR, Latrobe, PA (US)

(73) Assignee: Kennametal Inc., Latrobe, PA (US)

(21) Appl. No.: 18/917,036

(22) Filed: Oct. 16, 2024

(51) Int. Cl. B23C 5/22

(52) U.S. Cl. CPC B23C 5/2247; B23C 5/2213; B23C 2200/0461; B23C 2220/56

(57) ABSTRACT

A plungeable cutting apparatus can include a cutting tool having at least one cutting insert. Each cutting insert can have a body sized and configured to define at least one cutting edge that is positioned for cutting into a work piece to define a recess, groove or other type of aperture. Some embodiments of the cutting apparatus can utilize an array of cutting inserts positioned along a distal periphery of a cutting tool of the cutting apparatus, for example. Each cutting insert can have a generally square configuration or other suitable shape. Some embodiments can be sized and shaped to help limit vibration during metalworking to help improve the life of the cutting insert and facilitate larger sized aperture formation via plungeable cutting operations that may also need less finishing work.

### FIELD OF THE INVENTION

The present invention relates to plunge cutting tools (e.g. plunge milling, etc.) and cutting inserts for cutting tools (e.g. cutting inserts for plunge cutting mills, etc.).

### BACKGROUND OF THE INVENTION

Examples of cutting tool assemblies can be found in U.S. Pat. Nos. 3,811,163, 7,220,083, 7,976,250, 8,162,572, 8,454,279, 8,596,935, 9,011,049, 9,079,251, 9,114,463, 9,180,532, 9,180,650, 9,700,969, 9,981,323, 11,534,842, and 11,806,796. Cutting tools can be used in metalworking, for example. Some cutting tools can be stationary. Other types of cutting tools can be moveable (e.g. rotatable, etc.). A cutting tool can be utilized to manipulate a workpiece to form holes, recesses, grooves, or other types of apertures for forming a device, a part, or a component part, for example.

### SUMMARY OF THE INVENTION

I determined that some cutting tools can experience substantial limitations in plunge milling operations. For example, conventional approaches can utilize tools that are often unable to accommodate high feed processing due to strength and rigidity limitations, which can affect the sizing for cutting inserts and the amount of material that can be removed in a plunging operation. Many approaches for plunge milling involve use of a cutting insert that has a vertically extending edge that extends outwardly as the edge extends from the top of the cutting insert to the bottom of the cutting insert (e.g. a bottom of the cutting edge extends more outwardly than the top region). I have surprisingly found that this can result in limitations in the cutting of a workpiece.

For example, plunge milling often utilizes a cutting tool having cutting inserts that are positioned and sized so that there is a leading edge portion of the cutting edge of each insert that is at a bottom of the cutting insert or in a lower portion of a cutting insert. I have surprisingly found that this type of approach can result in material removal operations during plunge milling that can provide rougher, less precise material removal that may need a significant amount of finishing work after an initial cut is made to form a particular type of aperture (e.g. groove, etc.). Also, I have surprisingly found that this type of approach can negatively affect the strength and rigidity of the cutting inserts, which can limit the feed rate of the cutting operations and depth to which the plunging of the cutting can move in a single plunge operation. These types of limitations can reduce operational flexibility and require longer production times for cutting operations. This can be particularly true for cutting operations that may require deep cutting to be performed.

Embodiments of a plunge cutting apparatus and cutting insert for such an apparatus can be provided that can address these types of limitations and may also provide other benefits for different types of cutting objectives. Embodiments can be sized and configured to provide improved strength and rigidity for plunge milling operations that can also provide improved operational efficiency in making deep cuts (e.g. forming deep slots, grooves, etc.) into a workpiece. Embodiments can be configured to help provide a reduction in vibration while also providing a higher throughput of processing, which can be provided even though an average amount of material removed per cutting insert may be less than conventional designs (e.g. embodiments can provide a higher material removal rate per plunge even though each cutting insert may remove less material per insert as compared to conventional designs). Such advantages can be provided via improved rigidity and strength, which can permit a plunge to move more deeply into a work piece and also permit the cutting tool to be rotated more quickly for removal of material during a plunge. Further, the decrease in amount of material to be removed per cutting insert can allow for a more refined cutting operation that can result in a decrease in the time needed to perform finishing work after the initial aperture is formed via the plunge milling operation.

The performance and improvement that embodiments may provide is surprising because conventionally plunge milling operations are designed to provide high radial engagement with a lower feed of material per cutting inset (e.g. a larger amount of material is removed per cutting insert, but at a lower rate of feed to the cutting process to facilitate this operation). This is often the design approach because conventionally designs for cutting inserts for plunge milling seeks to have low radial cutting forces since those forces are often responsible for tool deformation and workpiece deformation, can be very small in such designs. However, I have surprisingly found that embodiments can be provided that can provide improved processing capacity with improved cutting performance and precision that can provide greater operational flexibility even though a higher radial cutting force may be applied. I have surprisingly found that embodiments can provide such advantages even though the average amount of material removed per cutting insert in some embodiments may be less than a conventional design for a plunge milling operation.

In a first aspect, a plungeable cutting apparatus can be provided. Embodiments of the plungeable cutting apparatus can include a cutting tool having a body. The body of the cutting tool can have an intermediate portion between a distal first end and a proximate second end. The body of the cutting tool can also have a plurality of projections positioned along a periphery of the distal first end. A plurality of cutting inserts can also be provided. Each of the cutting inserts can be attached to a respective one of the projections. Each of the cutting inserts can be positioned to have a cutting edge that extends vertically from a lower end of the cutting edge to an upper end of the cutting edge along a pre-selected leading angle such that the upper end of the cutting edge is more outwardly positioned than the lower end of the cutting edge.

In some embodiments, there can be a plurality of projections that include a first projection and a second projection and a plurality of cutting inserts that can include a first cutting insert and a second cutting insert. The first cutting insert can be attached to the first projection and the second cutting insert can be attached to the second projection. In other embodiments, there can be a third projection, fourth projection and/or a fifth projection and there can also be a third cutting insert attached to the third projection, a fourth cutting insert attached to the fourth projection and/or a fifth cutting insert attached to the fifth projection. Yet other embodiments can have more than five cutting inserts and more than five projections.

In a second aspect, the pre-selected leading angle can be between 0° and 25° or 0° and 30° . In some embodiments, the pre-selected leading angle can be an angle between 0°-15°, 3°-18° or 5°-15°.

In a third aspect, the cutting edge can be sized and configured so that the cutting edge has a maximum depth of cut that is no more than 4 mm and is greater than 0 mm. In some such embodiments, the pre-selected leading angle can be between 0° and 30°. For example, in some embodiments, the cutting edge can be sized and configured so that the cutting edge has a maximum depth of cut that is no more than 2 mm and is greater than 0 mm and the pre-selected leading angle can be between 0° and 30° (e.g. can be between 5° and 15°).

In a fourth aspect, each of the cutting inserts can have a first inner face positioned to contact the respective one of the projections to which the cutting insert is attached and a second outer face opposite the first inner face. Each of the cutting inserts can also have having a plurality of sides that extend from the first inner face to the second outer face. In some embodiments, each of the sides can be tapered and/or each of the sides can have at least one recess.

For example, in some embodiments, each of the cutting inserts can have a first inner face positioned to contact the respective one of the projections to which the cutting insert is attached and a second outer face opposite the first inner face. Each of the cutting inserts can also have a plurality of sides and a plurality of corners. In some embodiments, the plurality of sides can include: a first side extending from the first inner face to the second outer face, a second side extending from the first inner face to the second outer face, a third side extending from the first inner face to the second outer face such that the second side extends between the first side and the third side, and a fourth side extending from the first inner face to the second outer face such that the third side extends between the second side and the fourth side and the fourth side extends between the third side and the first side, the first side extending between the fourth side and the second side.

In some embodiments, the plurality of corners can include a first corner extending from the first inner face to the second outer face at an interface between the first side and the second side, a second corner extending from the first inner face to the second outer face at an interface between the second side and the third side, a third corner extending from the first inner face to the second outer face at an interface between the third side and the fourth side, and a fourth corner extending from the first inner face to the second outer face at an interface between the fourth side and the first side.

In some embodiments, each corner of the plurality of corners can have at least one radius segment. For example, some of the corners can have more than one radius segment and other corners can have only one radius segment. In other embodiments, all the corners can have a similar number of radius segments and each of the radius segments can have a different radius dimension.

In a fifth aspect, the cutting edge can be defined at an interface between an outer face of the cutting insert and one of the sides of the cutting insert.

In a sixth aspect, each of the cutting inserts can be positioned to provide raking (e.g. positive raking or negative raking). In some embodiments, each of the cutting inserts is in a tilted position to provide positive raking or negative raking, for example.

In a seventh aspect, the cutting edge can be a linearly extending cutting edge, can include one or more linearly extending segments, can include one or more curved segments or can include a combination of at least one linearly extending segment and at least one curved segment. For instance, in some embodiments, the cutting edge can include at least one straight segment and/or at least one curved segment.

In an eighth aspect, each of the cutting inserts can have a double sided configuration. Such a configuration can permit the inner face and outer face of the cutting insert to be switched around to account for wear or other factors.

In a ninth aspect, the apparatus of the first aspect can include one or more elements of the second aspect, the third aspect, the fourth aspect, the fifth aspect, the sixth aspect, the seventh aspect, and/or the eighth aspect. Some embodiments can also include other elements or features. Examples of these other elements or features can be appreciated from the discussion of exemplary embodiments provided herein.

In a tenth aspect, a cutting insert for a cutting tool of a plungeable cutting apparatus is provided. The cutting insert can include a first inner face positioned to contact a projection of a body of a cutting tool to which the cutting insert is attachable and a second outer face opposite the first inner face. The cutting insert can also include a first side extending from the first inner face to the second outer face, a second side extending from the first inner face to the second outer face, a third side extending from the first inner face to the second outer face such that the second side extends between the first side and the third side, and a fourth side extending from the first inner face to the second outer face such that the third side extends between the second side and the fourth side and the fourth side extends between the third side and the first side, and the first side extending between the fourth side and the second side. The cutting insert can also include a first corner extending from the first inner face to the second outer face at an interface between the first side and the second side, a second corner extending from the first inner face to the second outer face at an interface between the second side and the third side, a third corner extending from the first inner face to the second outer face at an interface between the third side and the fourth side, and a fourth corner extending from the first inner face to the second outer face at an interface between the fourth side and the first side. A cutting edge can be defined at an interface between the second outer face and one of the sides. The cutting edge can extend vertically from a lower end of the cutting edge to an upper end of the cutting edge along a pre-selected leading angle such that the upper end of the cutting edge is more outwardly positioned than the lower end of the cutting edge.

In some embodiments, the pre-selected leading angle can be between 0° and 30°. In some embodiments, the pre-selected leading angle can be an angle in a range of 0°-15°, 0°-25°, 3°-18° or 5°-15°, for example.

In an eleventh aspect, the cutting edge can be sized and configured so that the cutting edge has a maximum depth of cut that is no more than 4 mm and is greater than 0 mm. For instance, in some embodiments, the cutting edge can be sized and configured so that the cutting edge has a maximum depth of cut that is no more than 2 mm and is greater than 0 mm.

In twelfth aspect, the first side, second side, third side, fourth side, first corner, second corner, third corner, and fourth corner can be configured so that the first face has a same configuration as the second face. Such a configuration can permit the cutting insert to have a double sided configuration, for example.

In a thirteenth aspect, the cutting insert of the tenth aspect can include one or more features of the eleventh aspect and/or the twelfth aspect. Embodiments can also include other features or elements, examples of which can be appreciated from the discussion of exemplary embodiments provided herein.

In a fourteenth aspect, a process for forming at least one aperture into a workpiece is provided. Embodiments of the process can include moving a cutting tool along a horizontal path of motion over a workpiece so that the cutting tool is stopped at multiple different plunging positions along the horizontal path so that, at each of the plunging positions, the cutting tool is rotated and moved vertically from an initial position into the workpiece to a pre-selected depth within the workpiece. Each of the plunging positions can be spaced apart from an immediately adjacent plunging position of the plunging positions by a pre-selected step over distance to provide a pre-selected depth of cut that is no more than 4 mm and is greater than 0 mm. In some embodiments, the cutting tool utilized in the process can include an embodiment of the cutting apparatus and/or cutting insert discussed herein.

For instance, in some embodiments, the cutting tool can include a body having an intermediate portion between a distal first end and a proximate second end. The body of the cutting tool can have a plurality of projections positioned along a periphery of the distal first end. The cutting tool can also include a plurality of cutting inserts. Each of the cutting inserts can be attached to a respective one of the projections. Each of the cutting inserts can be positioned to have a cutting edge that extends vertically from a lower end of the cutting edge to an upper end of the cutting edge along a pre-selected leading angle such that the upper end of the cutting edge is more outwardly positioned than the lower end of the cutting edge.

In some embodiments, the pre-selected step over distance is no more than 100 mm and is greater than or equal to 20 mm. In other embodiments, the pre-selected step over distance can be another spacing (e.g. up to 40 mm, up to 50 mm, greater than 0 mm and up a pre-selected maximum distance that can be in a range of 40 mm to 60 mm, etc.).

In some embodiments, the pre-selected depth of cut can be no more than 2 mm and the cutting edge can be sized and configured so that the cutting edge has a maximum depth of cut that is no more than 2 mm and is greater than 0 mm. In some such embodiments, the pre-selected leading angle can be between 0° and 30°.

Embodiments of the process can utilize different embodiments of the cutting apparatus and/or cutting insert. Embodiments can also include other features or elements, examples of which can be appreciated from the discussion of exemplary embodiments provided herein.

These and other embodiments shall be described in more detail herein and in the drawings that show exemplary embodiments. Therefore, other details, objects, and advantages will become apparent as the following description of certain present preferred embodiments thereof and certain present preferred methods of practicing the same proceeds.

### BRIEF DESCRIPTION OF THE DRAWINGS

Exemplary embodiments of a cutting apparatus, a cutting insert for a plungeable cutting apparatus, and methods of making and using the same are shown in the accompanying drawings. It should be appreciated that like reference numbers used in the drawings may identify like components:

FIG. 1 is a perspective view of a first exemplary embodiment of a plungeable cutting apparatus 1 illustrating exemplary embodiments of cutting inserts 5 that can be positioned about a periphery of distal end of a plungeable and rotatable body 2 of the cutting tool 3 of the cutting apparatus 1.

FIG. 2 is an enlarged fragmentary side view of the first exemplary embodiment of a plungeable cutting apparatus 1 illustrating a first exemplary embodiment of a cutting insert 5 of the cutting tool 3 engaging a workpiece 7 to remove material from the workpiece 7.

FIG. 3 is an enlarged fragmentary side view of the first exemplary embodiment of a plungeable cutting apparatus 1 illustrating a second exemplary embodiment of a cutting insert 5 of the cutting tool 3 engaging a workpiece 7 to remove material from the workpiece 7.

FIG. 4 is a perspective view of another exemplary embodiment of a cutting insert 5 that can be utilized in exemplary embodiments of the cutting tool 3 of the plungeable cutting apparatus 1.

FIG. 5 is a perspective view of the second exemplary embodiment of the cutting insert 5 of the cutting tool 3 that can be utilized in exemplary embodiments of the cutting tool 3 of the plungeable cutting apparatus 1.

FIG. 6 is a perspective view of a third second exemplary embodiment of the cutting insert 5 of the cutting tool 3 that can be utilized in exemplary embodiments of the cutting tool 3 of the plungeable cutting apparatus 1.

FIG. 7 is a side view of a first exemplary embodiment of a plungeable cutting apparatus 1 illustrating a first exemplary arrangement of exemplary embodiments of cutting inserts 5 that can be positioned about a periphery of distal end of a plungeable and rotatable body 2 of the cutting tool 3 of the cutting apparatus 1.

FIG. 8 is a side view of a first exemplary embodiment of a plungeable cutting apparatus 1 illustrating a second exemplary arrangement of exemplary embodiments of cutting inserts 5 that can be positioned about a periphery of distal end of a plungeable and rotatable body 2 of the cutting tool 3 of the cutting apparatus 1 to provide negative raking.

FIG. 9 is a side view of a first exemplary embodiment of a plungeable cutting apparatus 1 illustrating a second exemplary arrangement of exemplary embodiments of cutting inserts 5 that can be positioned about a periphery of distal end of a plungeable and rotatable body 2 of the cutting tool 3 of the cutting apparatus 1 to provide positive raking.

FIG. 10 is a top view of a top 7t of an exemplary workpiece 7 having an aperture being formed therein via plunging of an exemplary embodiment of a cutting tool 3 into the workpiece 7 to form the aperture by moving along a pre-selected horizontal path HP of motion in which the cutting tool is stopped for plunging into and out of the workpiece 7 at different positions spaced apart by a pre-selected step over SO distance that extends horizontally along the horizontal path HP of motion. A pre-selected scallop height SH can be provided via the cuts formed via the different plunges of the cutting tool 3, which can be smoothed or otherwise removed via grinding or other finishing processing that may occur after the pre-selected aperture is formed in the workpiece 7 via the motion and plunging of the cutting tool 3.

FIG. 11 is a flow chart illustrating a first exemplary embodiment of a method of forming an aperture in a workpiece via use of a plungeable cutting apparatus 1.

### DESCRIPTION

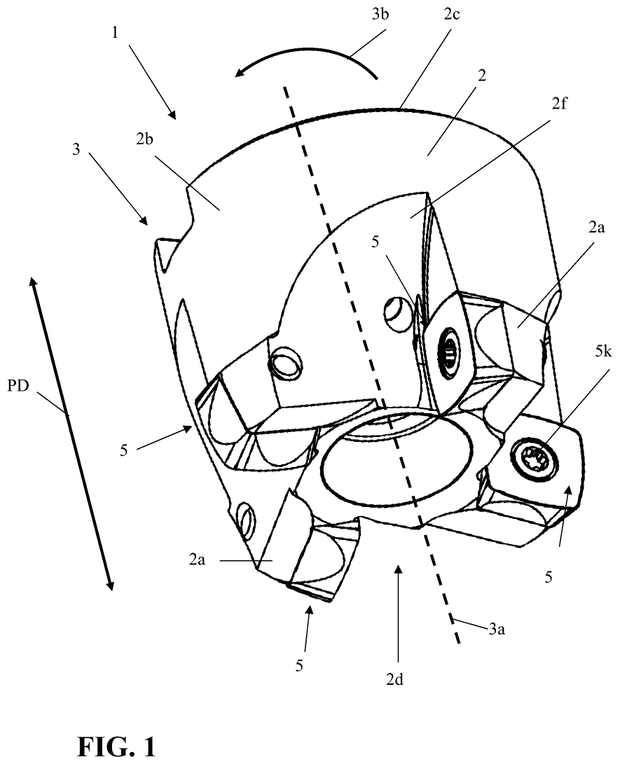

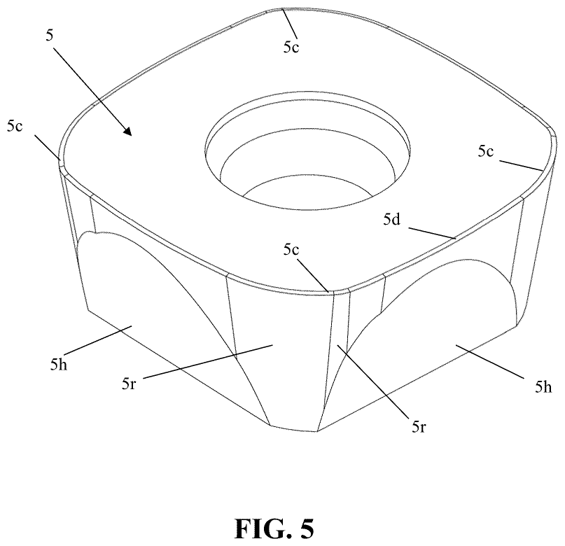

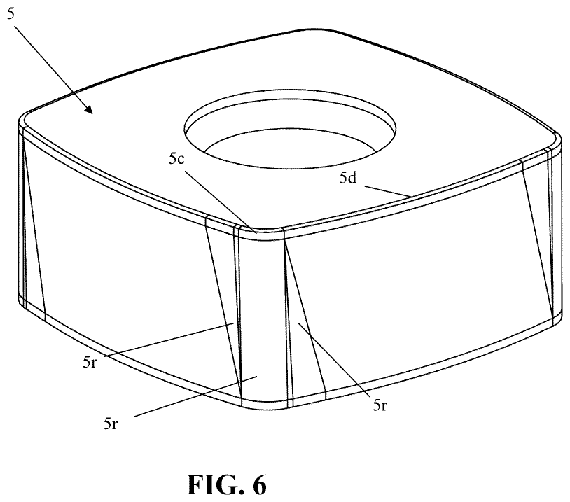

Referring to FIG. 1 through FIG. 9, a plungeable cutting apparatus 1 can include a cutting tool 3 that has a body 2 that is sized and configured to retain multiple cutting inserts 5. The cutting tool 3 can be moved vertically to plunge into a workpiece 7 and can be rotated about a vertical axis 3a in a rotational direction 3b while the cutting tool 3 is moved vertically downward into a workpiece 7 for removal of material from the workpiece 7 to form an aperture within the workpiece (e.g. a slot, a groove, an elongated groove, a recess, etc.). After being moved downward to a pre-selected depth into the workpiece, the cutting tool 3 can be raised in an opposite upward direction to complete a cycle of plunging motion.

The cutting tool 3 can be moved along a path horizontally to different discrete locations for being plunged via a plunging motion in the vertical plunging direction PD into and out of a workpiece 7 to form an aperture within the workpiece 7. After each plunge, the cutting tool 3 can be moved to a new horizontal location and subsequently be moved vertically into and out of the workpiece 7 for being subsequently moved to a new location for a subsequent plunge to form the aperture within the workpiece 7. The cutting tool 3 can be rotated when being plunged into and out of the workpiece 7 to cut the aperture into the workpiece 7.

The cutting inserts 5 of the cutting tool 3 can be sized and configured to cut away metal material or other material from a metal workpiece 7, for example (e.g. a steel workpiece, other type of metal workpiece, etc.). Some embodiments can be configured so that the cutting inserts 5 are comprised of a tungsten carbide material, a polycrystalline Diamond (PCD) material, a ceramic material, a polycrystalline cubic boron nitride material, a cubic boron nitride (CBN) material, a carbide material, or other suitable material for cutting material from a metal workpiece 7 (e.g. a steel workpiece, a lead workpiece, a copper workpiece, etc.).

The body 2 of the cutting tool 3 can have an intermediate portion 2b that is positioned between its distal first end 2d and its proximate second end 2c. The proximate second end 2c can be configured for attachment to a rotational member of a drive mechanism that can be configured to drive rotational motion of the cutting tool 3 in the rotational direction 3b while the cutting tool is moved vertically downward to plunge into a workpiece to for an aperture within the workpiece 7. The first end 2d of the body can have multiple cutting insert retaining projections 2a that are positioned and configured to retain cutting inserts 5 thereon via at least one fastener 6 and/or other fastening mechanism. The projections 2a can be spaced apart from each other and defined so that there are flutes 2f defined between different projections 2a. For example, some embodiments can include two or more projections 2a and two or more flutes 2f. Each flute 2f can be a recessed portion of the first end 2d that can be sized and shaped to help facilitate a motion of cut material so that the material is moved away from the cutting insert 5 and/or cutting tool 3 as the cutting tool is rotated.

The projections 2a can be spaced apart from each other and positioned along a periphery of the first end 2d of the body 2b of the cutting tool 3. The projections 2a can be sized and configured so that rotation of the body 2 of the cutting tool 3 can result in the cutting inserts 5 positioned on the projections 2a contacting a body of a workpiece to engage and cut the work piece to remove material from the work piece as the body 2 is moved downwardly in a plunging motion while also being rotated in the rotational direction 3b about the vertical axis 3a of the cutting tool 3.

In some embodiments, the body 2 of the cutting tool 3 can have a central chamber or other type of aperture defined therein to facilitate a connection of the cutting tool to a drive mechanism for plunging and rotation of the cutting tool. For example, the body 2 of the cutting tool 3 can have a central aperture for being connected to a portion of a computer numerical control (CNC) milling machine for being plunged vertically while also being rotated.

In some embodiments, such as the exemplary embodiment shown in FIG. 1, there can be four projections 2a and four flutes 2f wherein there is a flute 2f defined between immediately adjacent projections 2a. Other embodiments can be configured to have more than four projections 2a and more than four flutes 2f. Yet other embodiments can be configured to have only two projections 2a and two flutes 2f or only three projections 2a and three flutes 2f.

The cutting inserts 5 of the cutting tool 3 can each be attached to a respective one of the projections 2a via a fastener 6 that can be passed through a central hole 5k defined in a body of the cutting insert 5. The fastener 6 can be a bolt, screw, or other type of fastener. The projection 2a can have a hole or receptacle that can be aligned with the hole 5k of the cutting insert 5 for receipt of the fastener 6 for attachment of the cutting insert 5 to the projection 2a so that an inner face 5b of the cutting insert 5 contacts a surface of the projection 2a for being retained thereon via the fastener 6 and/or other fastening mechanism. An outer face 5a of the cutting inserts 5 can be opposite the inner face 5b. The inner face 5b can be considered a projection facing end of the body of the cutting insert 5 and the outer face 5a can be considered an outwardly facing end of the body of the cutting insert 5 that is opposite its projection facing end.

Each cutting insert 5 can have a generally polygonal shaped body (e.g. square-like shaped body, rectangular shaped body, polygonal shaped body, etc.) that have multiple sides 5s that can extend between the inner face 5b and the outer face 5a to define different sides 5s of the body of the cutting insert 5. Each side 5s of the body can have a similar configuration in some embodiments. For example, each side 5s can taper outwardly from the inner face 5b to the outer face 5a and have at least one recess 5h defined therein. The tapering of each side 5s can be provided so that the cutting insert 5, when attached to the projection 2a, has a cutting edge 5d that can have a relatively minimal portion that may overhang the projection 2a (e.g. may only have a minimal upper segment that may slightly overhang the projection 2a such that the cutting edge 5d may only extend outwardly away from the axis 3a of the cutting tool beyond the outer side of the projection 2a to which the cutting insert 5 is attached by a relatively minimal distance or may only have an upper end portion that may extend slightly outwardly away from the axis 3a of the cutting tool beyond the outer side of the projection 2a to which the cutting insert 5 is attached).

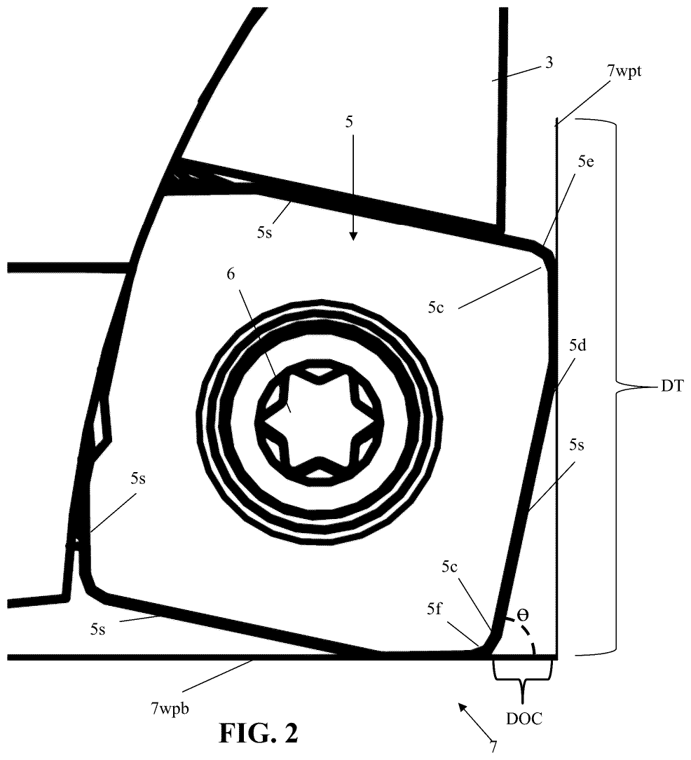

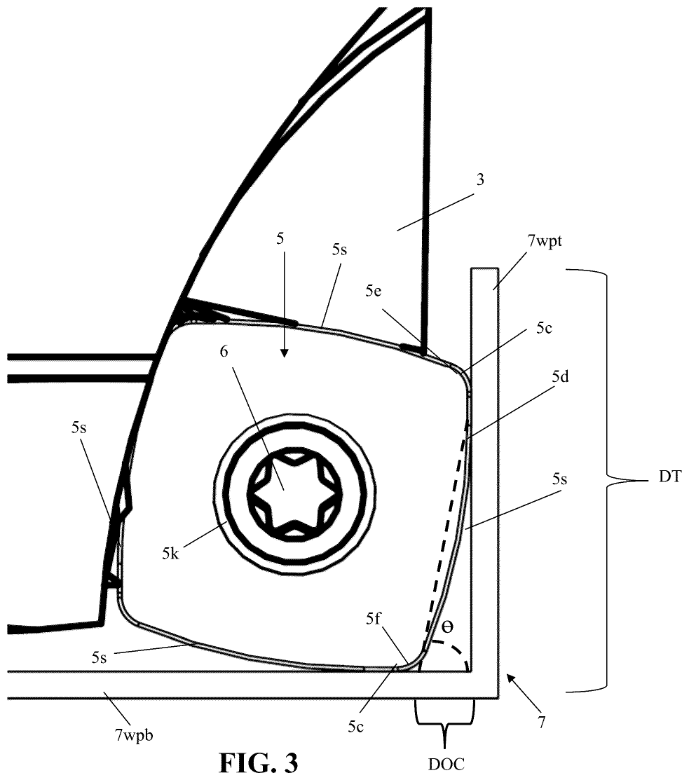

As may best be seen from FIG. 2 and FIG. 3, at least one of the sides 5s of the body of the cutting insert 5 can have an interface with the outer face 5a to define a cutting edge 5d. The cutting edge 5d can be rounded or curved or can be a linearly extending straight edge. At least one side 5s can interface with the second outer face 5a to define a cutting edge 5d such that an upper end 5e of the cutting edge 5d is the most outward portion of the cutting edge 5d (e.g. is more outward than a lower end 5f and also more outward than an intermediate portion of the cutting edge that can extend from the upper end to the lower end).

In some embodiments, each outwardly facing side 5s positioned to contact the workpiece 7 can have a cutting edge 5d. For example, there can be vertically extending cutting edge 5d and a lower cutting edge defined by the outermost vertically extending side 5s of the cutting insert 5 and the lowermost side 5s of the cutting insert. In other embodiments, the cutting insert 5 may have only a vertically extending cutting edge 5d. The vertically extending cutting edge 5d can extend from an upper end of a side 5s to a lower end 5f of the side 5s. The upper end 5e can be positioned more outward relative to the lower end 5f such that there is a pre-selected leading angle θ about which the side 5s extends from the lower end 5f to the upper end 5e. The pre-selected leading angle θ can be defined so that there is a maximum depth of cut (DOC) that can be defined by the cutting edge 5d of the cutting insert 5 as the cutting edge 5d extends along the pre-selected angle θ from the lower end 5f of the cutting edge 5d to the upper end 5e of the vertically extending cutting edge 5d. In some embodiments, the cutting edge 5d can be defined and shaped to extend linearly between the lower end 5f to the upper end 5e along the pre-selected leading angle θ. In some embodiments, the pre-selected leading angle θ can be between 0° and 30°, between 3° and 25°, or between 5° and 15°. The DOC that can be defined by the cutting edge 5d can be between greater than 0 mm and 4 mm or between greater than 0 mm and 2 mm in some embodiments.

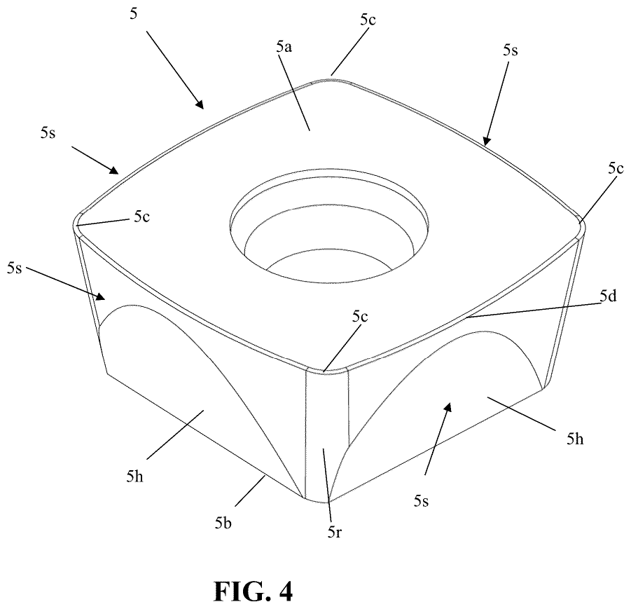

The lower end 5f and upper end 5e of the cutting edge can each be positioned adjacent at least one radius segment 5r that can extend between the ends of adjacent sides 5s to define a corner 5c of a body of the cutting insert at opposites ends of the cutting edge 5d of the cutting insert 5. The one or more radius segments 5r can be positioned to define corners 5c, which can each be at interfaces between adjacent sides 5s of the body of the cutting insert 5. Some embodiments may utilize a single radius segment 5r at each interface between adjacent sides 5s to define corners 5c of the body of the cutting insert 5 (see e.g. FIG. 4). Other embodiments can utilize multiple different radius segments 5r that can be positioned immediately adjacent to each other to provide different radial lengths and curve segments of a corner 5c so each corner 5c of the body of the cutting insert can have a pre-selected rounded shape.

Each radial segment 5r can extend between the inner face 5b and the outer face 5b of the cutting insert between the sides 5s of the cutting insert 5 to define corners 5c of the body of the cutting insert. In some embodiments, the radial segments 5r can also define facets of the cutting insert.

Some embodiments of the cutting insert 5 can be generally square shaped cutting inserts 5 that can have a first side 5s, second side 5s, third side 5s, and fourth side 5s that extend between the inner face 5b and outer face 5a of the body of the cutting insert 5a. There can be a first corner 5c defined by one or more radial segments 5f positioned between the first side 5s and the second side 5s, a second corner 5c defined by one or more radial segments 5f positioned between the second side 5s and the third side 5s, a third corner 5c defined by one or more radial segments 5f positioned between the third side 5s and the fourth side 5s, and a fourth corner 5c defined by one or more radial segments 5f positioned between the fourth side 5s and the first side 5s. The one or more radial segments 5r can be provided to define rounded corners 5c between adjacent sides 5s, for example. The cutting insert 5 can be attached to a projection 2a of the cutting tool body 2 so a cutting edge 5d extends from a lower end of a side 5s to an upper end of the side 5s adjacent an interface between the side 5s and the outer face 5a. The cutting edge can extend vertically along the pre-selected leading angle θ from a lower end 5f to an upper end 5d of the cutting edge 5d. The size and shape of the cutting insert can define a cutting edge 5d having a maximum DOC that is between greater than 0 mm and 4 mm in some embodiments.

The cutting inserts 5 can be configured to have an outer face 5a and an inner face 5b that are mirror images, or double sided in configuration. For example, each corner 5c can include radius segments 5r that permit the different faces of the cutting inserts 5 to have the same shape and cutting profile and the sides can extend between the corners 5c so that the sides 5s have a similar shape regardless of whether of whether the outer face 5a is installed to face a projection 2a or positioned to face outwardly away from the projection 2a.

In some embodiments, the body of the cutting insert can include a first corner 5c extending from the first inner face 5b to the second outer face 5a at an interface between the first side 5s and the second side 5s, a second corner 5c extending from the first inner face 5b to the second outer face 5a at an interface between the second side 5s and the third side 5s, a third corner 5c extending from the first inner face 5b to the second outer face 5a at an interface between the third side 5s and the fourth side 5s, and a fourth corner 5c extending from the first inner face 5b to the second outer face 5a at an interface between the fourth side 5s and the first side 5s. Such a body configuration can be generally rectangular or square in shape in some embodiments. Each corner 5c can include one or more radial segments (e.g. a single radial segment, multiple radial segments, etc.).

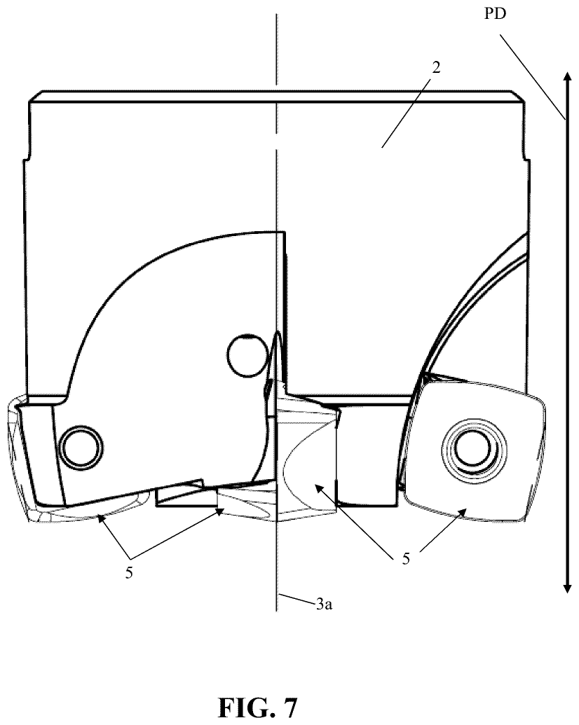

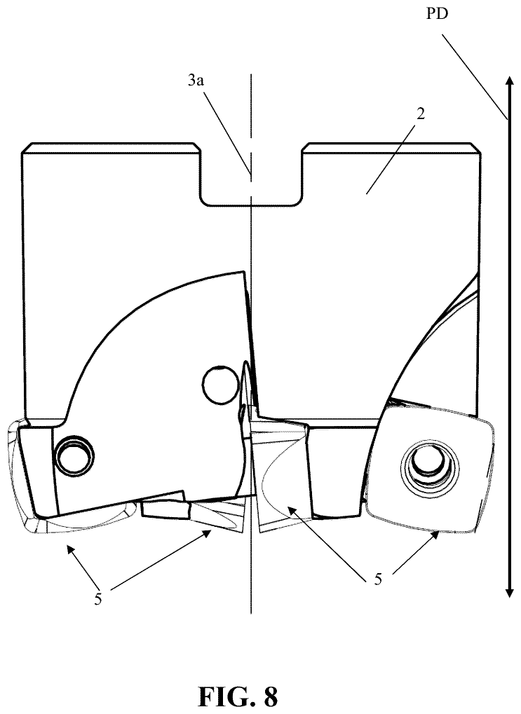

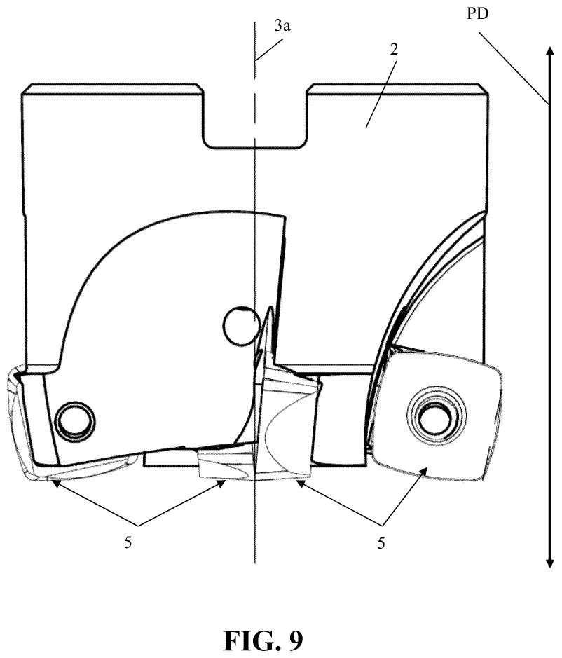

At least some of the cutting inserts 5 can be oriented for attachment to the projections 2a to provide different types of raking orientations for cutting of a workpiece as well. For example, at least some of the cutting inserts 5 can be positioned to have a neutral raking profile (FIG. 7), a negative raking profile (FIG. 8), or a positive raking profile (FIG. 9). In a neutral raking profile (an example of which is shown in FIG. 7), cutting inserts 5 can be oriented so the cutting edge 5d extends vertically at an angle as shown in FIG. 2 or FIG. 3 and the cutting inserts 5 are also not tilted relative to a horizontal at an angle (e.g. there is 0° of tilting relative to a horizontal axis.

In a negative raking position (an example of which is shown in FIG. 8), cutting inserts 5 can be oriented so the cutting edge 5d extends vertically at an angle as shown in FIG. 2 or FIG. 3 while the cutting inserts 5 are also tilted about a horizontal axis so its upper portion is tilted forwardly and is more forward than its lower portion as shown in FIG. 8, for example. Tilting of the cutting inserts 5 about a central horizontal axis of the cutting inserts 5 at an angle of greater than 0° to 20° can provide such an orientation, for example.

In a positive raking position (an example of which is shown in FIG. 9), cutting inserts 5 can be oriented so the cutting edge 5d extends vertically at an angle as shown in FIG. 2 or FIG. 3 while the cutting inserts are also tilted about a central horizontal axis so lower portions of the cutting inserts 5 are more forwardly positioned then the upper portions of the cutting inserts 5 (e.g. the forwardmost portion of each cutting insert is its lower portion that is positioned more forwardly than the upper portion of the cutting insert). Tilting of the cutting inserts5 about the central horizontal axis of an angle of greater than 0° to −20° can provide such an orientation, for example.

The positive, neutral, or negative raking profile orientations for cutting inserts 5 can be provided for cutting of the lower surface of a workpiece for forming a desired shaped aperture. The cutting insert orientation can be selected to meet a particular desired set of cutting criteria for plunge milling an aperture in a workpiece, for example.

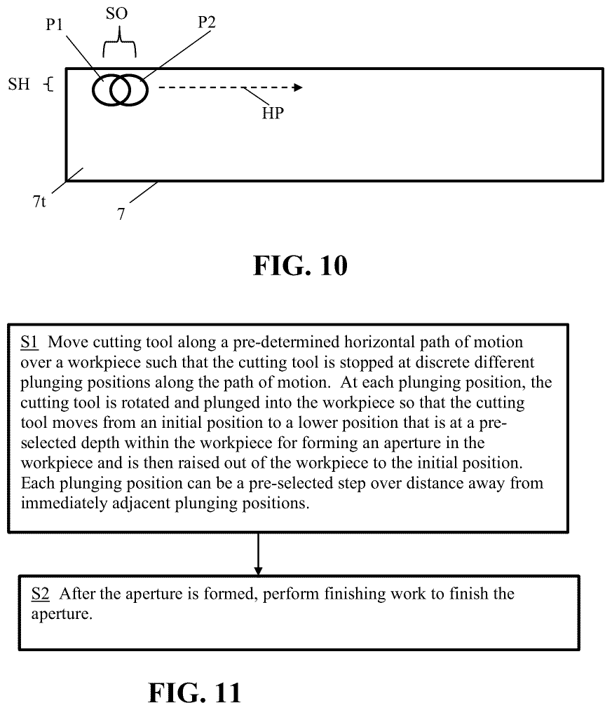

As may best be seen from FIG. 10 and FIG. 11, embodiments of the cutting tool 3 can be utilized in the plungeable cutting apparatus 1 so that the cutting tool 3 can be moved along a pre-selected horizontal path HP of motion to form a pre-defined aperture into a top 7t of a workpiece 7. At different discrete plunging positions along the horizontal path of motion, the cutting tool's horizontal motion along the horizontal path HP of motion can be stopped to be plunged vertically into and out of the top of the workpiece 7 to form a segment of the aperture to be formed having a pre-selected depth into the workpiece 7 in a first step S1. This pre-selected depth DT can extend from an upper portion 7wpt of the workpiece to a lower portion 7wpb of the workpiece that is below the upper portion 7wpt of the workpiece. In some embodiments, the pre-selected depth DT can be between 10 cm and 40 cm or between greater than 0 mm and 500 mm.

For instance, the cutting tool 3 can be moved along a pre-determined horizontal path HP of motion over a workpiece 7 such that the cutting tool 3 is stopped at discrete different plunging positions along the path of motion. At each plunging position, the cutting tool 3 can be rotated and plunged into the workpiece 7 so that the cutting tool 3 moves from an initial position to a lower position that is at a pre-selected depth within the workpiece 7 while the cutting tool 3 is rotated for forming an aperture in the workpiece 7 and is then raised out of the workpiece 7 to the initial position. Each plunging position can be a pre-selected step over distance SO away from immediately adjacent plunging positions. In some embodiments, the pre-selected step over distance SO can be between 20 mm and 100 mm (e.g. 20 mm to 50 mm, 20 mm to 80 mm, etc.).

After the desired aperture is cut into the workpiece, a second step S2 of the method can be performed for finishing the aperture by further grinding of different portions of the workpiece adjacent the formed aperture to finish the aperture so the aperture may a desired finished shape and the surfaces of the sidewalls and/or bottom of the aperture can have a desired surface finish.

For example, FIG. 10 illustrates an aperture being formed in which the cutting tool 3 has been moved horizontally along the horizontal path HP of motion and plunged into the workpiece 7 at a first plunge position P1 and a second plunge position P2 that is a pre-selected step over distance SO form the first plunge position P1. Each discrete position in which the cutting tool 3 is plunged into and out of the workpiece to the pre-selected depth can be a pre-defined or pre-selected step over distance SO from a prior immediately adjacent plunging of the cutting tool (e.g. each plunge of the cutting tool 3 can be spaced apart from the next plunge by the pre-selected step over distance SO). The cutting inserts 5 of the cutting tool 3 can engage the workpiece 7 as the cutting tool is rotated during plunging to form aperture segments that have a scallop height SH, which may be defined by the depth of cut (DOC) of the cutting edges 5d of the cutting inserts 5 being rotated and the diameter of the distal first end 2d of the body of the cutting tool 3. The DOC can be between greater than 0 mm and 4 mm and the scallop height SH can be no more than 4 mm and greater than 0 mm in such embodiments.

The workpiece 7 can have an aperture formed therein via plunging of the cutting tool 3 into the workpiece 7 to form the aperture by moving along the pre-selected horizontal path HP of motion in which the cutting tool is stopped for plunging into and out of the workpiece 7 at different positions spaced apart by a pre-selected step over distance SO that extends horizontally along the horizontal path HP of motion. The pre-selected scallop height SH can be provided via the cuts formed via the different plunges of the cutting tool 3, which can be smoothed or otherwise removed via grinding or other finishing processing that may occur after the pre-selected aperture is formed in the workpiece 7 via the motion of the cutting tool 3 along the horizontal path HP of motion and discrete vertical plunging of the cutting tool 3 that can occur at pre-selected locations along the horizontal path of motion. The size of the scallop height SH can be affected by the DOC of the cutting edges 5d of the cutting inserts 5 that are rotated via rotation of the cutting tool 3 during the plunging into and out of the workpiece 7 to form the aperture.

Embodiments of the cutting insert 5 can be provided for attachment to projections 2a of the body 2 of the cutting tool 3 so that the scallop height SH can be relatively small (e.g. less than 2 mm in some embodiments, less than 4 mm in some embodiments, etc.) while the pre-selected step over distance SO can be about the width or diameter of the body of the cutting tool 3 (e.g. between 20 mm and 100 mm, etc.). The sizing and positioning of the cutting inserts 5 and projections 2a can be provided so that a diameter or width of the body of each cutting insert 5 is substantially the same as the width or diameter of the projection 2a that retains the cutting insert to help increase the rigidity of the cutting insert and the cutting tool 3 having the cutting inserts fastened to the projections 2a. In some embodiments, the inner face 5b can match or substantially match the size of the cutting insert receiving surface of the projection 2a (e.g. be the same or within 5% of the same size and shape) and the sides 5s can be tapered sidewalls that taper to the second outer face 5a so that the cutting edge 5d of the cutting insert 5 is more outward relative to the projection 2a to which the cutting insert is attached to provide a clearance for the pre-selected depth of cut while also providing an improved rigidity and strength when the cutting tool 3 is plunged and rotated for cutting a workpiece 7.

As noted above, a process of making at least one aperture in a workpiece 7 via utilization of the cutting tool 3 in a plunge milling operation can include a first step of including the cutting tool in a plunge milling device and subsequently using the cutting tool to perform a pre-defined plunge milling operation to form the aperture. This process can include moving the cutting tool along a horizontal path of motion such that at different discrete positions along a top 7t of a workpiece, the cutting tool is rotated and vertically plunged to a pre-selected or pre-determined depth into the workpiece while the cutting tool 3 is rotated. After each plunge, the cutting tool can be moved a pre-selected step over distance SO along the horizontal path of motion and subsequently plunged again while the cutting tool is rotated to form the pre-determined aperture in the workpiece. Each plunge of the cutting tool can include moving the cutting tool while it is rotated vertically downward in a linear fashion to the pre-selected depth into the workpiece and subsequently lifting the cutting tool 3 back to an initial height over the workpiece 7. After each completed plunge, the cutting tool 3 can be moved horizontally by a pre-selected step over distance SO along the horizontal path of motion and then plunged again. The cycle of plunging and horizontal motion of a pre-selected step over distance SO along the horizontal path of motion can be repeated until the cutting tool 3 has been moved along the entire predefined horizontal path of motion. After the aperture is formed, the workpiece 7 can subsequently undergo further grinding or other finishing work to account for the scallop height of the different cuts made by each plunge as may be needed to provide a desired finished dimension and surface to the formed aperture(s) defined in the workpiece 7.

Embodiments can be provided so that even though the cutting edges 5d of the cutting inserts may have a smaller DOC, there can be substantially more material removed via the plunging operation due to an increased depth of plunging that can be provided as a consequence of the improved rigidity and strength of the connection and rigidity between the cutting inserts 5 and projections 2a and/or an improved speed of cutting that can be provided for horizontal adjustment of the position of the cutting tool 3 due to the smaller DOC and greater depth of plunging that may be provided.

This type of functionality can also permit reduced vibration during cutting, which also helps contributed to the improved material rate of removal and improved, increased depth of cutting that can be provided via a plunge of the cutting tool 3. For instance, I have found that the reduction in vibration that can be provided can facilitate deeper cuts in longer, or deeper, plunges of the cutting tool 3 during a plunge for each plunge of the cutting tool 3. Some embodiments can provide a material rate of removal (MRR) that can be 2-8 times greater than conventional plunge milling utilizing conventional cutting tools even through each cutting insert of an embodiment of the cutting tool 3 may remove less material per cutting insert as compared to the conventional cutting inserts used in conventional plunge mill processing.

Further, the smaller scallop height that can be provided via the smaller DOC can permit processing to occur so that less finishing work is needed to finish a formed aperture formed in a workpiece. This can help further improve processing by making the processing of forming a particular component occur more quickly and more efficiently. This can also help provide improved manufacturing flexibility as less time and resources for finishing may need to be allocated for manufacturing any particular part or component.

I have surprisingly found that this combination of features can help provide a significant improvement in operation. This can be particularly true for deep depth apertures (e.g. deep slots or cavities of over 10 cm or over 50 cm in depth). Further, the smaller DOC that may be effectively utilized to provide a higher MRR can permit operations to define deeper and more finished corners in different aperture structures to be cut into a workpiece 7. I have surprisingly found that embodiment of the cutting tool 3 utilizing the cutting inserts 5 fastened to projections 2a can be utilized to provide relatively lower radial engagement in each plunge in a way that provides an overall higher MRR due to the increased depth of cutting that can be used during plunge milling operations.

It should be appreciated that the exemplary embodiments discussed herein can be adjusted to account for a particular set of design criteria. For example, the size and shape of the body of cutting insert 5, the size and shape of flutes 2f, size and shape of the body 2 of the cutting tool 3, and the type of materials utilized for the cutting insert 5 and cutting tool body 2 can be any of a number of different options. For instance, the type of material used for the body of the cutting insert 5 and/or body 2 of the cutting tool 3 can be carbide, cemented carbine, tungsten carbide, ceramic material, steel, tool steel, etc. As yet another example, the moveable body 2 of the cutting tool 3 can be a rotatable member connected to an actuator that can vertically move the cutting tool 3 up and down and also rotate the cutting tool 3 in at least one rotational direction. Thus, while certain present preferred embodiments of the plungeable cutting apparatus 1, cutting insert 5, and embodiments of methods for making and using the same have been shown and described above, it is to be distinctly understood that the invention is not limited thereto but may be otherwise variously embodied and practiced within the scope of the following claims.

What is claimed is:

1. A plungeable cutting apparatus comprising:
a cutting tool having a body, the body of the cutting tool having an intermediate portion between a distal first end and a proximate second end, the body of the cutting tool having a plurality of projections positioned along a periphery of the distal first end;
a plurality of cutting inserts, each of the cutting inserts attached to a respective one of the projections, each of the cutting inserts positioned to have a cutting edge that extends vertically from a lower end of the cutting edge to an upper end of the cutting edge along a pre-selected leading angle such that the upper end of the cutting edge is more outwardly positioned than the lower end of the cutting edge.

2. The plungeable cutting apparatus of claim 1, wherein the pre-selected leading angle is between 0° and 25°.

3. The plungeable cutting apparatus of claim 1, wherein the cutting edge is sized and configured so that the cutting edge has a maximum depth of cut that is no more than 4 mm and is greater than 0 mm and wherein the pre-selected leading angle is between 0° and 30°.

4. The plungeable cutting apparatus of claim 1, wherein the cutting edge is sized and configured so that the cutting edge has a maximum depth of cut that is no more than 2 mm and is greater than 0 mm and wherein the pre-selected leading angle is between 5° and 15°.

5. The plungeable cutting apparatus of claim 1, wherein each of the cutting inserts has a first inner face positioned to contact the respective one of the projections to which the cutting insert is attached and a second outer face opposite the first inner face, each of the cutting inserts also having a plurality of sides that extend from the first inner face to the second outer face.

6. The plungeable cutting apparatus of claim 1, wherein each of the cutting inserts has a first inner face positioned to contact the respective one of the projections to which the cutting insert is attached and a second outer face opposite the first inner face, each of the cutting inserts also having a plurality of sides and a plurality of corners, the plurality of sides and the plurality of corners including:
a first side extending from the first inner face to the second outer face, a second side extending from the first inner face to the second outer face, a third side extending from the first inner face to the second outer face such that the second side extends between the first side and the third side, and a fourth side extending from the first inner face to the second outer face such that the third side extends between the second side and the fourth side and the fourth side extends between the third side and the first side, the first side extending between the fourth side and the second side; and
a first corner extending from the first inner face to the second outer face at an interface between the first side and the second side, a second corner extending from the first inner face to the second outer face at an interface between the second side and the third side, a third corner extending from the first inner face to the second outer face at an interface between the third side and the fourth side, and a fourth corner extending from the first inner face to the second outer face at an interface between the fourth side and the first side.

7. The plungeable cutting apparatus of claim 6, wherein each corner of the plurality of corners has at least one radius segment.

8. The plungeable cutting apparatus of claim 1, wherein each of the cutting inserts has a first inner face positioned to contact the respective one of the projections to which the cutting insert is attached and a second outer face opposite the first inner face, each of the cutting inserts also having a plurality of sides that extend from the first inner face to the second outer face; and
wherein the cutting edge is defined at an interface between the second outer face and one of the sides.

9. The plungeable cutting apparatus of claim 1, wherein each of the sides is tapered and/or each of the sides has at least one recess.

10. The plungeable cutting apparatus of claim 1, wherein each of the cutting inserts is in a tilted position to provide positive raking or negative raking.

11. The plungeable cutting apparatus of claim 1, wherein the cutting edge includes at least one straight segment and/or at least one curved segment.

12. The plungeable cutting apparatus of claim 1, wherein each of the cutting inserts have a double sided configuration.

13. A cutting insert for a cutting tool of a plungeable cutting apparatus, the cutting insert comprising:
a first inner face positioned to contact a projection of a body of a cutting tool to which the cutting insert is attachable and a second outer face opposite the first inner face;
a first side extending from the first inner face to the second outer face, a second side extending from the first inner face to the second outer face, a third side extending from the first inner face to the second outer face such that the second side extends between the first side and the third side, and a fourth side extending from the first inner face to the second outer face such that the third side extends between the second side and the fourth side and the fourth side extends between the third side and the first side, the first side extending between the fourth side and the second side;
a first corner extending from the first inner face to the second outer face at an interface between the first side and the second side, a second corner extending from the first inner face to the second outer face at an interface between the second side and the third side, a third corner extending from the first inner face to the second outer face at an interface between the third side and the fourth side, and a fourth corner extending from the first inner face to the second outer face at an interface between the fourth side and the first side;
a cutting edge defined at an interface between the second outer face and one of the sides, the cutting edge extending vertically from a lower end of the cutting edge to an upper end of the cutting edge along a pre-selected leading angle such that the upper end of the cutting edge is more outwardly positioned than the lower end of the cutting edge.

14. The cutting insert of claim 13, wherein the pre-selected leading angle is between 0° and 30°.

15. The cutting insert of claim 13, wherein the cutting edge is sized and configured so that the cutting edge has a maximum depth of cut that is no more than 4 mm and is greater than 0 mm.

16. The cutting insert of claim 13, wherein the cutting edge is sized and configured so that the cutting edge has a maximum depth of cut that is no more than 2 mm and is greater than 0 mm and wherein the pre-selected leading angle is between 5° and 15°.

17. The cutting insert of claim 13, wherein the first side, second side, third side, fourth side, first corner, second corner, third corner, and fourth corner are configured so that the first face has a same configuration as the second face.

18. A process for forming at least one aperture into a workpiece, the process comprising:
moving a cutting tool along a horizontal path of motion over a workpiece so that the cutting tool is stopped at multiple different plunging positions along the horizontal path so that, at each of the plunging positions, the cutting tool is rotated and moved vertically from an initial position into the workpiece to a pre-selected depth within the workpiece, each of the plunging positions being spaced apart from an immediately adjacent plunging position of the plunging positions by a pre-selected step over distance to provide a pre-selected depth of cut that is no more than 4 mm and is greater than 0 mm, and
wherein the cutting tool comprises:
a body, the body of the cutting tool having an intermediate portion between a distal first end and a proximate second end, the body of the cutting tool having a plurality of projections positioned along a periphery of the distal first end, and
a plurality of cutting inserts, each of the cutting inserts attached to a respective one of the projections, each of the cutting inserts positioned to have a cutting edge that extends vertically from a lower end of the cutting edge to an upper end of the cutting edge along a pre-selected leading angle such that the upper end of the cutting edge is more outwardly positioned than the lower end of the cutting edge.

19. The process of claim 18, wherein the pre-selected step over distance is no more than 100 mm and is greater than or equal to 20 mm.

20. The process of claim 18, wherein the pre-selected depth of cut is no more than 2 mm and the cutting edge is sized and configured so that the cutting edge has a maximum depth of cut that is no more than 2 mm and is greater than 0 mm and wherein the pre-selected leading angle is between 0° and 30°.
